(19) United States
(12) Patent Application Publication
(10) Pub. No.: US 2025/0265179 A1
(43) Pub. Date: Aug. 21, 2025

(54) MACHINE LEARNING-BASED STABILITY DETERMINATION AND CONTROL OF TEST SCRIPTS FOR TEST CASES

(71) Applicant: Dell Products L.P., Round Rock, TX (US)

(72) Inventors: Ramakanth Kanagovi, Hyderabad (IN); Saheli Saha, Kolkata (IN); Prerit Jain, New Delhi (IN)

(21) Appl. No.: 18/582,029

(22) Filed: Feb. 20, 2024

(51) Int. Cl. G06F 11/36; G06N 3/0455

(52) U.S. Cl. CPC G06F 11/3696; G06F 11/3684; G06N 3/0455

(57) ABSTRACT

An apparatus comprises at least one processing device configured to select a test case associated with a test script comprising functional code for testing an information technology asset and a test case description. The at least one processing device is also configured to generate, utilizing a first machine learning model, first pseudocode for the test script based at least in part on the functional code of the test script, and to generate, utilizing a second machine learning model, second pseudocode for the test script based at least in part on the test case description. The at least one processing device is further configured to determine a stability of the test script based at least in part on a similarity between the first and second pseudocode, and to automatically control one or more characteristics of the functional code of the test script based at least in part on the determined stability.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Software development processes typically include multiple environments, such as one or more development environments, an integration testing environment, a staging environment, and a production environment. New software code may be created by individual developers or small teams of developers in respective ones of the development environments. The integration environment provides a common environment where software code from the multiple developers is combined and tested before being provided to the staging environment. The staging environment is designed to emulate the production environment and may be used for final review and approval before new software code is deployed in production applications in the production environment. In some cases, software development processes implement continuous integration/continuous deployment (CI/CD) functionality to enable frequent and reliable delivery of code changes for software.

### SUMMARY

Illustrative embodiments of the present disclosure provide techniques for machine learning-based determination of stability of test scripts associated with test cases, and for automatic control of the test scripts for the test cases based at least in part on their determined stability.

In one embodiment, an apparatus comprises at least one processing device comprising a processor coupled to a memory. The at least one processing device is configured to select a test case, the selected test case being associated with (i) a test script comprising functional code for implementing the selected test case for testing an information technology asset and (ii) a test case description. The at least one processing device is also configured to generate, utilizing a first machine learning model, first pseudocode for the test script based at least in part on the functional code of the test script for the selected test case, and to generate, utilizing a second machine learning model, second pseudocode for the test script based at least in part on the test case description for the selected test case. The at least one processing device is further configured to determine a stability of the test script for the selected test case based at least in part on a similarity between the first pseudocode and the second pseudocode, and to automatically control one or more characteristics of the functional code of the test script for the selected test case based at least in part on the determined stability of the test script for the selected test case.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based determination of stability of test scripts associated with test cases in an illustrative embodiment.

FIG. 2 is a flow diagram of an exemplary process for machine learning-based determination of stability of test scripts associated with test cases in an illustrative embodiment.

FIG. 3 shows a system flow for fine-tuning a large language model to generate benchmark pseudocode based on test case descriptions and acceptance criteria in an illustrative embodiment.

FIG. 4 shows a system flow for generating stability scores for test cases in an illustrative embodiment.

FIG. 5 shows a table of stable historical test cases in an illustrative embodiment.

FIG. 6 shows an example of functional code for a test case in an illustrative embodiment.

FIG. 7 shows an example of actual test script pseudocode generated based on functional code for a test case in an illustrative embodiment.

FIG. 8 shows an example of acceptance criteria for a test case in an illustrative embodiment.

FIG. 9 shows an example of test case details for a test case in an illustrative embodiment.

FIG. 10 shows an example of a test case summary, test case description and test case acceptance criteria for a test case in an illustrative embodiment.

FIG. 11 shows an example of benchmark pseudocode generated for a test case based on the test case's description and acceptance criteria in an illustrative embodiment.

FIG. 12 shows an example of actual test script pseudocode generated for test case based on functional code of a test script for the test case in an illustrative embodiment.

FIG. 13 shows an example of identified gaps between actual test script pseudocode and benchmark pseudocode generated for a test case in an illustrative embodiment.

FIG. 14 shows an example of recommendations for addressing gaps between actual test script pseudocode and benchmark pseudocode generated for a test case in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

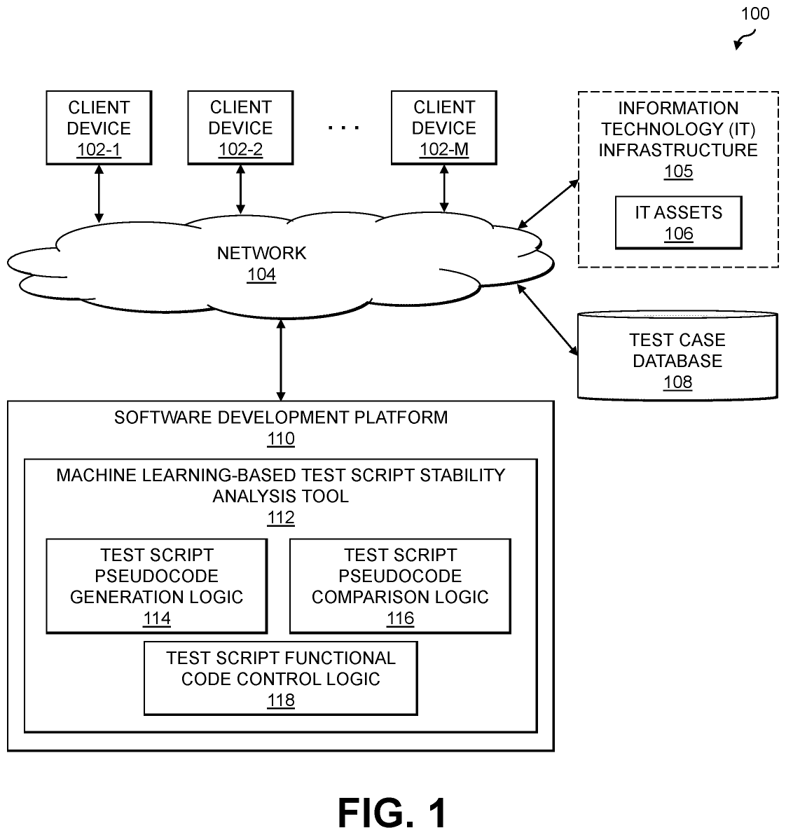

FIG. 1 shows an information processing system 100 configured in accordance with an illustrative embodiment. The information processing system 100 is assumed to be built on at least one processing platform and provides functionality for machine learning-based determination of stability of test scripts associated with test cases. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a test case database 108, and a software development platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the software development platform 110 is used for an enterprise system. For example, an enterprise may subscribe to or otherwise utilize the software development platform 110 for managing application or other software builds which are developed by users of that enterprise (e.g., software developers or other employees, customers or users which may be associated with different ones of the client devices 102 and/or IT assets 106 of the IT infrastructure 105). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The test case database 108 is configured to store and record various information that is utilized by the software development platform 110. Such information may include, for example, information that is collected regarding historical test cases used in testing of software code developed for different software products, where such information may include test case descriptions and acceptance criteria, test script functional code, actual pseudocode generated from test script functional code, benchmark pseudocode generated using test case descriptions and acceptance criteria, similarity scores calculated between actual and benchmark pseudocode for test cases, recommendations for modifying test scripts to reduce gaps or differences between actual and benchmark pseudocode for test cases, machine learning model (e.g., large language model (LLM)) configurations for machine learning models (e.g., LLMs) used for generating actual and benchmark pseudocode for test cases, for identifying gaps and recommendations for reducing the gaps between actual and benchmark pseudocode for test cases, etc. The test case database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the software development platform 110, as well as to support communication between the software development platform 110 and other related systems and devices not explicitly shown.

The software development platform 110 may be provided as a cloud service that is accessible by one or more of the client devices 102 to allow users thereof to manage development and deployment of software products. The client devices 102 may be configured to access or otherwise utilize the software development platform 110 (e.g., to create, develop and refine test cases for use in evaluating software code that has been or will be deployed on one or more of the IT assets 106, etc.). In some embodiments, the client devices 102 are assumed to be associated with software developers, system administrators, IT managers or other authorized personnel responsible for managing application or other software development for an enterprise. In some embodiments, the IT assets 106 of the IT infrastructure 105 are owned or operated by the same enterprise that operates the software development platform 110. In other embodiments, the IT assets 106 of the IT infrastructure 105 may be owned or operated by one or more enterprises different than the enterprise which operates the software development platform 110 (e.g., a first enterprise provides support for multiple different customers, businesses, etc.). Various other examples are possible.

In some embodiments, the client devices 102 and/or the IT assets 106 of the IT infrastructure 105 may implement host agents that are configured for automated transmission of information with the software development platform 110 regarding development of a particular application or other piece of software, including the development of test cases for such software. It should be noted that a “host agent” as this term is generally used herein may comprise an automated entity, such as a software entity running on a processing device. Accordingly, a host agent need not be a human entity.

The software development platform 110 in the FIG. 1 embodiment is assumed to be implemented using at least one processing device. Each such processing device generally comprises at least one processor and an associated memory, and implements one or more functional modules or logic for controlling certain features of the software development platform 110. In the FIG. 1 embodiment, the software development platform 110 implements a machine learning-based test script stability analysis tool 112. The machine learning-based test script stability analysis tool 112 comprises test script pseudocode generation logic 114, test script pseudocode comparison logic 116, and test script functional code control logic 118. The machine learning-based test script stability analysis tool 112 is configured to identify a given test case to be evaluated, to determine functional code of a test script for the given test case, and to determine a description and acceptance criteria for the given test case. The test script pseudocode generation logic 114 is configured to generate actual pseudocode for the test script for the given test case as well as benchmark or “gold standard” pseudocode for the given test case. The actual test script pseudocode is generated utilizing a first machine learning model (e.g., a first LLM), which takes as input the functional code for the test script for the given test case. The benchmark or gold standard pseudocode for the given test case is generated utilizing a second machine learning model (e.g., a second LLM, which has been fine-tuned based on historically stable test scripts). The test script pseudocode comparison logic 116 is configured to determine a similarity between the actual test script pseudocode and the benchmark or gold standard pseudocode for the given test case. The determined similarity is utilized to generate a stability score for the given test case (e.g., characterizing how closely the actual test script pseudocode corresponds to the benchmark or gold standard pseudocode for the given test case). The test script functional code control logic 118 is configured to automatically control one or more characteristics of the functional code of the test script for the given test case based at least in part on the determined stability of the test script for the given test case. This may include utilizing a third machine learning model (e.g., a third LLM, which may but is not required to be the same as the first LLM) to generate recommendations for modifying the test script for the given test case in order to remove any gaps between the actual test script pseudocode and the benchmark or gold standard pseudocode for the given test case, and automatically implementing one or more of the generated recommendations. Such automatic implementation of the generated recommendations may be conducted in response to a user accepting such recommendations, or possibly without any user input. For example, certain portions of the functional code (e.g., for less important portions of the functional code) may be altered automatically, while other portions of the functional code (e.g., for more important portions of the functional code) may require user approval before a recommended modification is automatically implemented. Various other examples are possible.

At least portions of the machine learning-based test script stability analysis tool 112, the test script pseudocode generation logic 114, the test script pseudocode comparison logic 116 and the test script functional code control logic 118 may be implemented at least in part in the form of software that is stored in memory and executed by a processor.

It is to be appreciated that the particular arrangement of the client devices 102, the IT infrastructure 105, the test case database 108 and the software development platform 110 illustrated in the FIG. 1 embodiment is presented by way of example only, and alternative arrangements can be used in other embodiments. As discussed above, for example, the software development platform 110 (or portions of components thereof, such as one or more of the machine learning-based test script stability analysis tool 112, the test script pseudocode generation logic 114, the test script pseudocode comparison logic 116 and the test script functional code control logic 118) may in some embodiments be implemented internal to the IT infrastructure 105.

The software development platform 110 and other portions of the information processing system 100, as will be described in further detail below, may be part of cloud infrastructure.

The software development platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the test case database 108 and the software development platform 110 or components thereof (e.g., the machine learning-based test script stability analysis tool 112, the test script pseudocode generation logic 114, the test script pseudocode comparison logic 116 and the test script functional code control logic 118) may be implemented on respective distinct processing platforms, although numerous other arrangements are possible. For example, in some embodiments at least portions of the software development platform 110 and one or more of the client devices 102, the IT infrastructure 105, the IT assets 106 and/or the test case database 108 are implemented on the same processing platform. A given client device (e.g., 102-1) can therefore be implemented at least in part within at least one processing platform that implements at least a portion of the software development platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the test case database 108 and the software development platform 110, or portions or components thereof, to reside in different data centers. Numerous other distributed implementations are possible. The software development platform 110 can also be implemented in a distributed manner across multiple data centers.

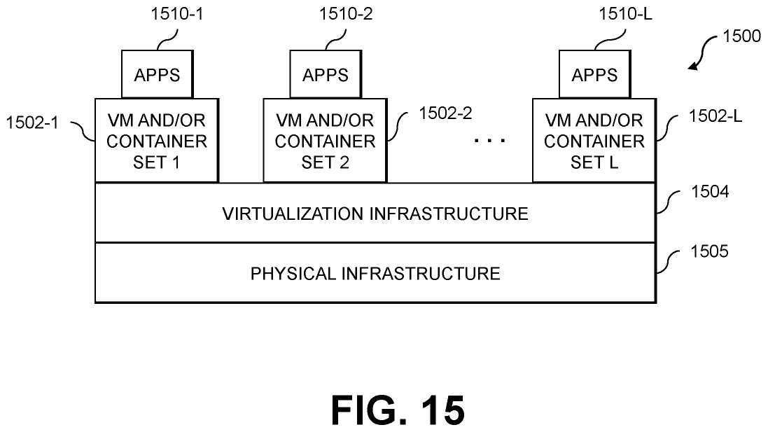

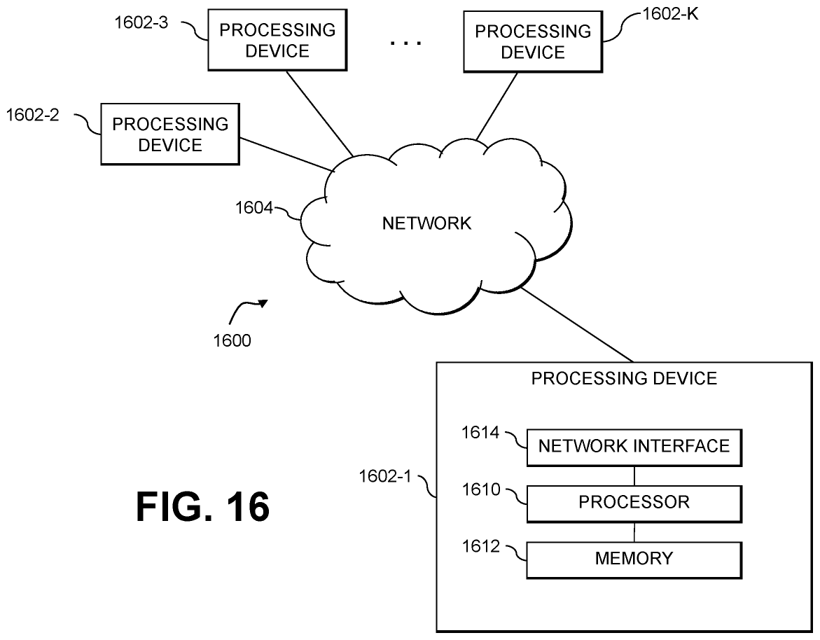

Additional examples of processing platforms utilized to implement the software development platform 110 and other components of the information processing system 100 in illustrative embodiments will be described in more detail below in conjunction with FIGS. 15 and 16.

It is to be understood that the particular set of elements shown in FIG. 1 for machine learning-based determination of stability of test scripts associated with test cases is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

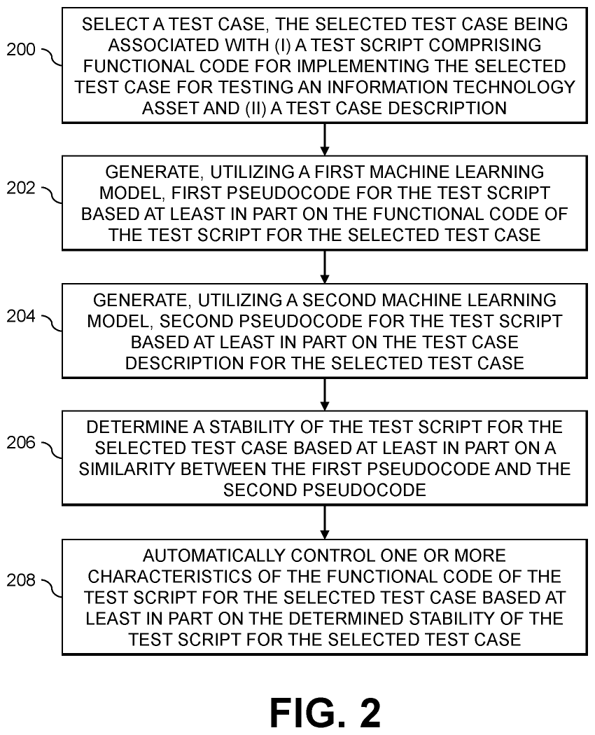

An exemplary process for machine learning-based determination of stability of test scripts associated with test cases will now be described in more detail with reference to the flow diagram of FIG. 2. It is to be understood that this particular process is only an example, and that additional or alternative processes for machine learning-based determination of stability of test scripts associated with test cases may be used in other embodiments.

In this embodiment, the process includes steps 200 through 208. These steps are assumed to be performed by the software development platform 110 utilizing the machine learning-based test script stability analysis tool 112, the test script pseudocode generation logic 114, the test script pseudocode comparison logic 116 and the test script functional code control logic 118. The process begins with step 200, selecting a test case, the selected test case being associated with (i) a test script comprising functional code for implementing the selected test case for testing an IT asset and (ii) a test case description. The test case description for the selected test case may comprise a text summary of the selected test case, one or more design documents for software to be tested on the IT asset, one or more software requirement specifications for the software to be tested on the IT asset, acceptance criteria for the selected test case, etc.

In step 202, first pseudocode for the test script is generated, utilizing a first machine learning model, based at least in part on the functional code of the test script for the selected test case. The first machine learning model may comprise an LLM that takes the functional code of the test script for the selected test case as a prompt and produces the first pseudocode as an output.

In step 204, second pseudocode for the test script is generated, utilizing a second machine learning model, based at least in part on the test case description for the selected test case. The second machine learning model may comprise an LLM that is tuned utilizing a set of one or more historical stable test cases. The FIG. 2 process may include tuning the second machine learning model utilizing a set of one or more historical test cases having determined stabilities exceeding a designated stability threshold. Tuning the second machine learning model may comprise generating pseudocode for the set of one or more historical test cases utilizing the first machine learning model based at least in part on functional code of test scripts of the set of one or more historical test cases, and training the second machine learning model utilizing test case descriptions for the set of one or more historical test cases as input and the generated pseudocode for the set of one or more historical test cases as output.

In step 206, a stability of the test script for the selected test case is determined based at least in part on a similarity between the first pseudocode and the second pseudocode. Determining the stability of the test script for the selected test case may comprise computing a cosine similarity between the first pseudocode and the second pseudocode.

In step 208, one or more characteristics of the functional code of the test script for the selected test case are automatically controlled based at least in part on the determined stability of the test script for the selected test case. In some embodiments, this includes generating one or more recommendations for modifying the functional code of the test script for the selected test case. The first machine learning model may comprise a first LLM and the second machine learning model may comprise a second LLM, the second LLM being different than the first LLM. Generating the one or more recommendations for modifying the functional code of the test script for the selected test case may comprise utilizing the first LLM or a third LLM different than the first LLM and the second LLM. Generating the one or more recommendations for modifying the functional code of the test script for the selected test case may comprise utilizing an LLM, where the LLM takes the first pseudocode and the second pseudocode as a text comparative prompt input and produces at least one of the one or more recommendations for modifying the functional code of the test script for the selected test case as output. The FIG. 2 process may further include automatically modifying the functional code of the test script for the selected test case based at least in part on the generated one or more recommendations.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In the realm of systems, application and software development engineering, the significance of automated test scripts for ensuring quality cannot be overstated. Test scripts serve as invaluable time-savers, allowing testers to concentrate on creating comprehensive test scripts to thereby enhance test coverage. Automated test scripts, however, come with their own set of challenges, especially in scenarios where the underlying code lacks stability and reliability. Therefore, the establishment of a stable and dependable coding framework becomes very important within the quality assurance domain.

With the advent of Large Language Models (LLMs), tools like OpenAI's Chat Generative Pre-Trained Transformer (ChatGPT) may be used to transform intricate functional code into more easily comprehensible pseudocode. While direct translation from pseudocode to functional code might not be entirely feasible, this process can serve as a constructive foundation for future development endeavors.

Illustrative embodiments provide technical solutions for utilizing machine learning to evaluate the stability of test scripts. In some embodiments, a scoring mechanism is used along with multiple LLMs (e.g., including open-source LLMs such as Llama 2 and OpenAI's ChatGPT). In some embodiments, different LLMs are used for distinct purposes across a stability score generation pipeline. The stability score generation pipeline, in some embodiments, includes using a first LLM (e.g., ChatGPT) to convert pre-existing automated test scripts (e.g., functional code) into pseudocode, with the resulting actual test script pseudocode being used for effectively assessing the quality of the automated test scripts. The resulting actual test script pseudocode is then compared against a benchmark (e.g., “gold standard”) pseudocode that corresponds to the test case of interest and its acceptance criteria. The benchmark or gold standard pseudocode is derived from a second LLM (e.g., Llama 2), which is fine-tuned to output the best possible pseudocode that aligns with historically successful test scripts, devoid of any past failures.

When evaluating the stability of a new test script, some embodiments employ a multi-step process. Initially, a first LLM is used to produce pseudocode for the new test script. Subsequently, a comparison is drawn between this pseudocode and benchmark or gold standard pseudocode produced by a second LLM (e.g., which is fine-tuned based on historical stable test scripts). If notable disparities emerge between the two versions of the pseudocode (e.g., signaling a considerable divergence from the benchmark), it indicates that the new test script might be suboptimal in terms of stability. In a final phase, a third LLM is used to generate insights into the divergence between the actual pseudocode and the benchmark or gold standard pseudocode. These insights are generated by employing text comparative prompts, facilitating the identification of areas where the new test script could be improved. It should be noted that the third LLM may, but is not required to be, the same as the first LLM. The technical solutions thus enhance the capabilities of LLMs to not only gauge the stability of test scripts, but also to guide the enhancement of coding practices for more reliable and effective automated testing.

The technical solutions provide various technical advantages, including through the use of generative artificial intelligence (AI)-driven pseudocode translation. By seamlessly incorporating LLMs into the workflow, the technical solutions in some embodiments explore an innovative approach of utilizing AI to translate complex functional code into user-friendly and more easily comprehensible pseudocode. Further, a “gold standard” or benchmark pseudocode generation model utilizes an LLM in an innovative manner. The technical solutions may involve fine-tuning an LLM based on the most effective test scripts, which are selected based on their historically low test failure rates. The test case details and acceptance criteria of the selected test scripts are taken as inputs for training the second LLM. This training is then utilized to develop the second LLM as a model capable of generating high-quality pseudocode (e.g., given a test case description and its acceptance criteria). This intelligent fine-tuned second LLM excels at producing benchmark or gold standard pseudocode for test case scripts.

Advantageously, the technical solutions described herein enable benchmarking of test script code stability through comparing pseudocode which is generated by different LLMs (e.g., a first LLM which generates actual test script pseudocode, and a second LLM which generates benchmark or gold standard test script pseudocode). This approach highlights a shift from traditional stability assessment techniques, showcasing adaptability to modern generative AI capabilities. In some embodiments, the comparison between the generated actual test script pseudocode and the generated benchmark or gold standard pseudocode is facilitated through the application of cosine similarity. A cosine similarity metric is used to indicate the degree of similarity between two sets of pseudocode, with a higher value suggesting a more stable test script and a lower value implying a less stable test script. This quantification advantageously provides a nuanced understanding of the stability levels achieved for an automated test script.

Beyond the comparison itself between the two sets of pseudocode, the technical solutions in some embodiments offer advanced capabilities for intelligent gap analysis and action recommendations. Once the actual test script pseudocode and the benchmark or gold standard pseudocode are juxtaposed, a machine learning model such as an LLM may be used to perform a comprehensive gap analysis via text comparison prompts. This insightful evaluation pinpoints the exact areas where differences exist, thereby revealing the precise gaps in the actual test script pseudocode's stability relative to the benchmark or gold standard pseudocode. To enhance the generated stability scores, the technical solutions in some embodiments generate actionable recommendations tailored to test engineers. These recommendations serve as coding guidance, suggesting corrective measures to bridge the stability gaps effectively.

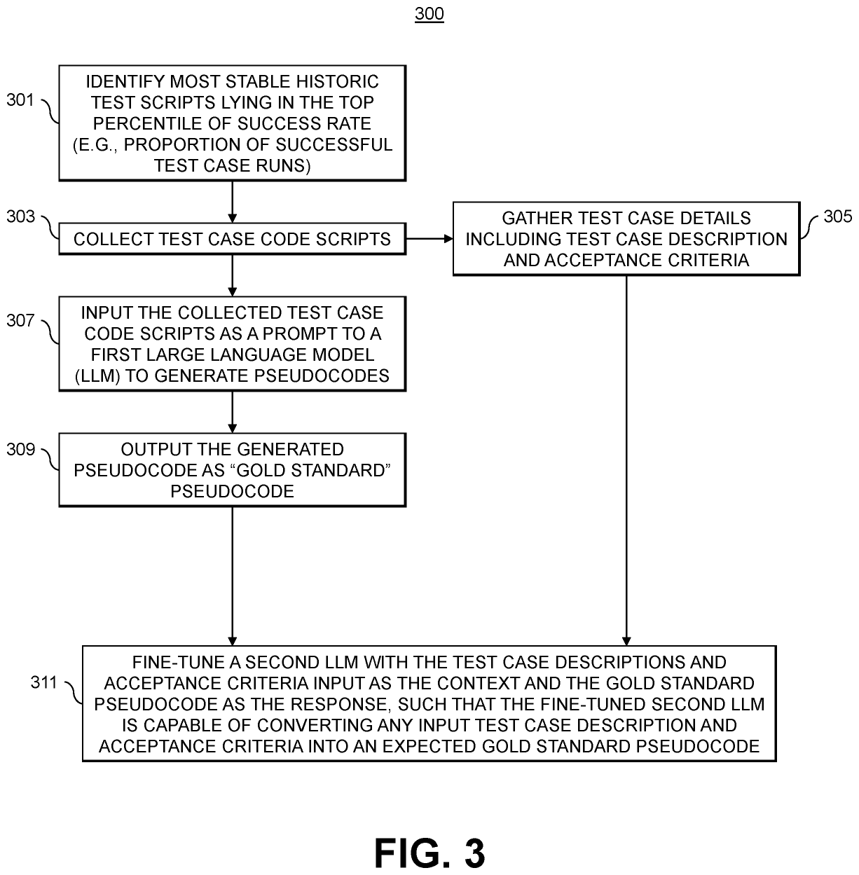

FIG. 3 shows a system flow 300 for generating a fine-tuned LLM configured to generate benchmark or gold standard pseudocode for a test script based on a test case's description and acceptance criteria. The system flow 300 begins in block 301 with identifying the most stable historical test scripts lying in the top percentile (e.g., top 1%, top 5%, top 10%, etc.) of success rate, where the success rate corresponds to a proportion of successful test case runs (e.g., the historical test scripts with the lowest failure percentage against the total number of test case runs). In block 303, code for the identified most stable historical test scripts are collected. In block 305, test case details including test case description and acceptance criteria for the identified most stable historical test scripts are gathered. In block 307, the test case code scripts collected in block 303 are input as a prompt to a first LLM to generate pseudocode for each of the test case code scripts.

The first LLM may comprise, for example, the OpenAI ChatGPT Pseudo Code Generator, which through in-context learning transforms the identified most stable historical test scripts into pseudocode. In block 309, the pseudocode generated by the first LLM are output as benchmark or gold standard pseudocode. In block 311, a second LLM is fine-tuned using the test case descriptions and acceptance criteria (gathered in block 305) input as the context and the gold standard pseudocode (generated as the output of the first LLM in block 309) as the response, such that the fine-tuned second LLM is capable of converting any input test case description and acceptance criteria into an expected gold standard pseudocode. The second LLM may comprise, for example, an open-source Llama 2 LLM, which is trained and fine-tuned to generate high-quality benchmark or gold standard pseudocode.

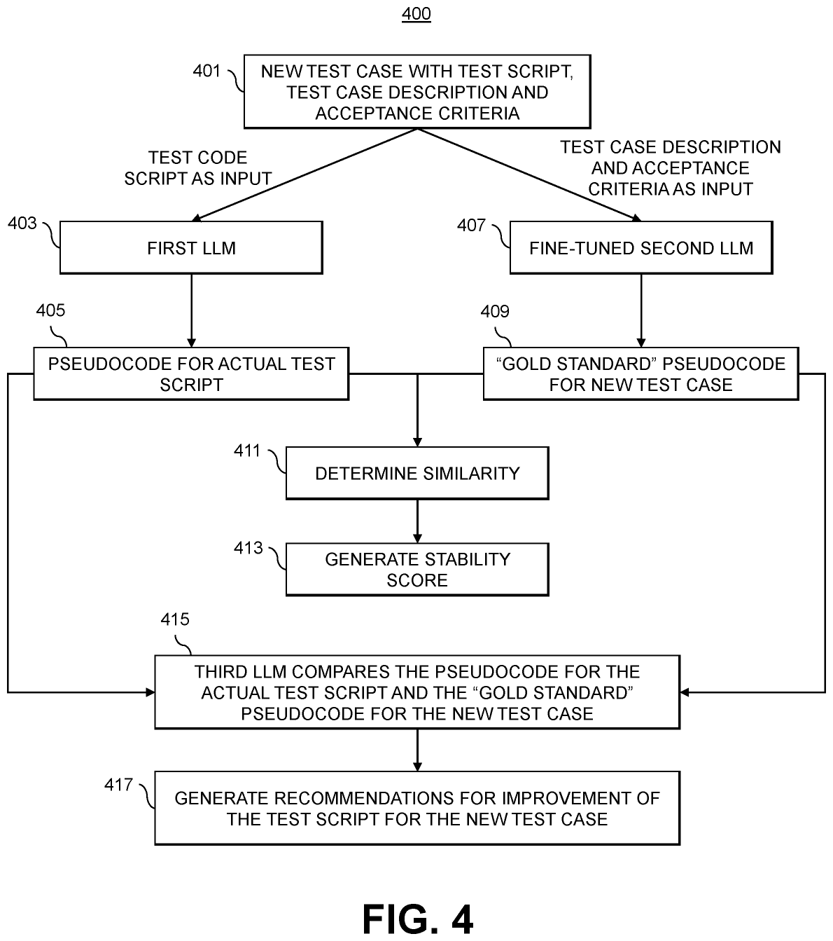

FIG. 4 shows a system flow 400 for generating test script stability scores and for generating recommendations for improvement of test script code. The system flow 400 begins in block 401 with determining a new test case, with the new test case having a test script, a test case description and acceptance criteria. In block 403, the test script for the new test case is input to the first LLM which outputs pseudocode for the actual test script in block 405. In block 407, the test case description and acceptance criteria for the new test case are input to the fine-tuned second LLM which outputs a benchmark or gold standard pseudocode for the new test case in block 409. In block 411, a similarity between the pseudocode for the actual test script and the benchmark or gold standard pseudocode for the new test case is determined. Block 411 may utilize a cosine similarity metric (e.g., where a higher cosine similarity indicates greater stability). In some embodiments, a threshold similarity (e.g., a threshold cosine similarity metric value) is defined in order to identify unstable test scripts. In block 413, a stability score for the new test case is generated based on the similarity determined in block 411. In block 415, a third LLM (which may, but is not required to be, the same as the first LLM (block 403)) is used to compare the pseudocode for the actual test script and the benchmark or gold standard pseudocode for the new test case. In some embodiments, the third LLM comprises an OpenAI ChatBot which is prompted to compare the pseudocode for the actual test script and the benchmark or gold standard pseudocode for the new test case in order to recommend the changes to fill in any gaps in the pseudocode for the actual test script. For example, text difference identification prompts may be used to pinpoint discrepancies between the pseudocode for the actual test script and the benchmark or gold standard pseudocode for the new test case. In block 417, recommendations for improvement of the test script for the new test case are generated based at least in part on the output of block 415. The recommendations generated in block 417 may be provide to a test engineer to allow the test engineer to enhance the test script (e.g., functional code thereof), such as by bridging the gaps between (i) the pseudocode for the actual test script and (ii) the benchmark or gold standard pseudocode for the new test case, thereby improving the stability of the test script's functional code. By following the comprehensive approach detailed in the system flows 300 and 400, the technical solutions in some embodiments are able to enhance the stability of test scripts, identify potential issues, and provide actionable recommendations for improvement. This iterative process ensures that the test scripts remain reliable and efficient over time.

The technical solutions describe herein may be used in a wide variety of use cases, including but not limited to code documentation, rapid prototyping, enhancing collaboration, automated code review, software architecture visualization, regression testing improvement, automated test case generation validation, optimized test coverage planning, and legacy code understanding.

For code documentation, the transformation of intricate functional code into pseudocode can serve as a documentation aid. Developers or other users can utilize the generated pseudocode to explain complex code structures and logic.

For rapid prototyping, when building a software solution, developers often require rapid prototyping to visualize the initial structure and functionality. Pseudocode generated by an LLM can offer a quick way to outline the basic logic of software before diving into full-fledged coding.

For enhancing collaboration, pseudocode acts as a universal language that can bridge the gap between developers and non-technical stakeholders. Using pseudocode to explain software concepts to business analysts, project managers or clients can facilitate effective communication and collaboration.

For automated code review, pseudocode comparison can extend beyond stability assessment. Pseudocode can be used as an additional tool in automated code review processes to identify sections of functional code that might require further examination or improvements.

For software architecture visualization, pseudocode can be used as a visual aid to illustrate the high-level architecture of software systems. Pseudocode can simplify complex system structures, helping architects and developers conceptualize the overall design.

For regression testing improvement, the technical solutions can significantly enhance regression testing practices. By comparing the pseudocode of existing test scripts with a benchmark gold standard, quality assurance (QA) teams can identify potential issues that might arise during regression testing. Deviations in pseudocode can indicate areas where the test script's stability has been compromised due to recent code changes. This allows testers to focus their efforts on areas that need attention and reduces the risk of regression bugs.

For automated test case generation validation, automated test case generation tools often produce a large number of test cases (with associated test scripts) based on various inputs and conditions. Evaluating the stability of these generated test cases is crucial. By using the technical solutions described herein, QA teams can prioritize generated test scripts for execution based on their stability scores. This ensures that stable test cases are tested first, minimizing the likelihood of false positives and negatives in test results.

For optimized test coverage planning, planning test coverage is a critical aspect of quality assurance. The technical solutions described herein provide the capability to assess the stability of test scripts and can aid QA teams in optimizing their test coverage strategies. By identifying stable and reliable test scripts, teams can allocate testing resources more effectively. This ensures that critical functionalities are thoroughly tested and minimizes the changes of missing important test scenarios due to unstable test scripts.

For legacy code understanding, when dealing with legacy codebases, pseudocode can provide a simplified representation of existing logic. This aids developers in understanding and maintaining legacy systems.

Thus, incorporating pseudocode and AI-generated comparisons into various stages of software development, education and communication can bring significant benefits by simplifying complex concepts, improving collaboration and enhancing the overall software development lifecycle.

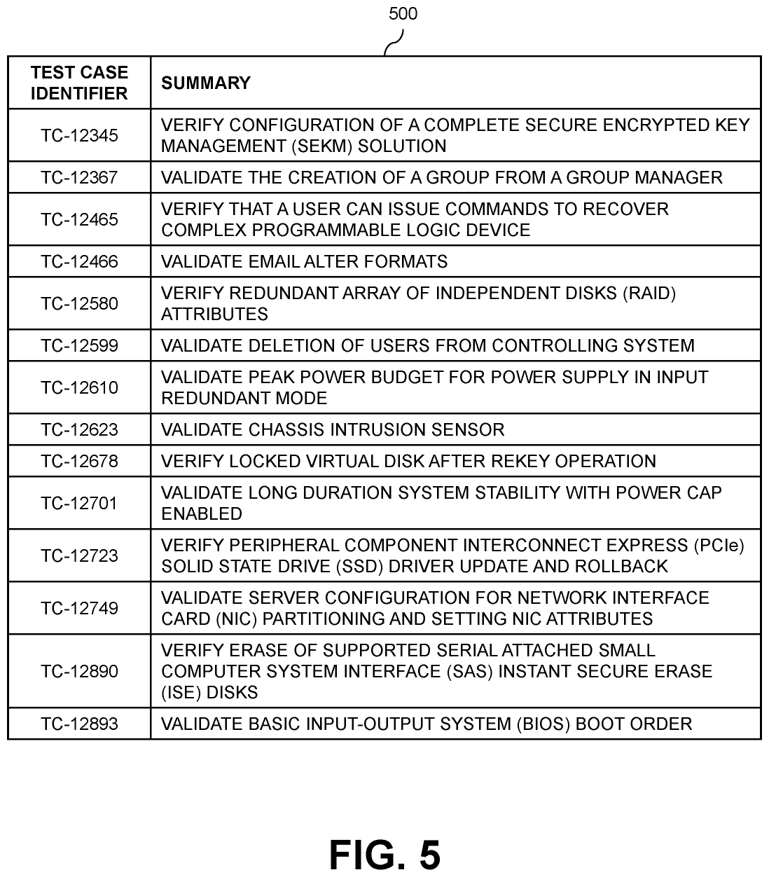

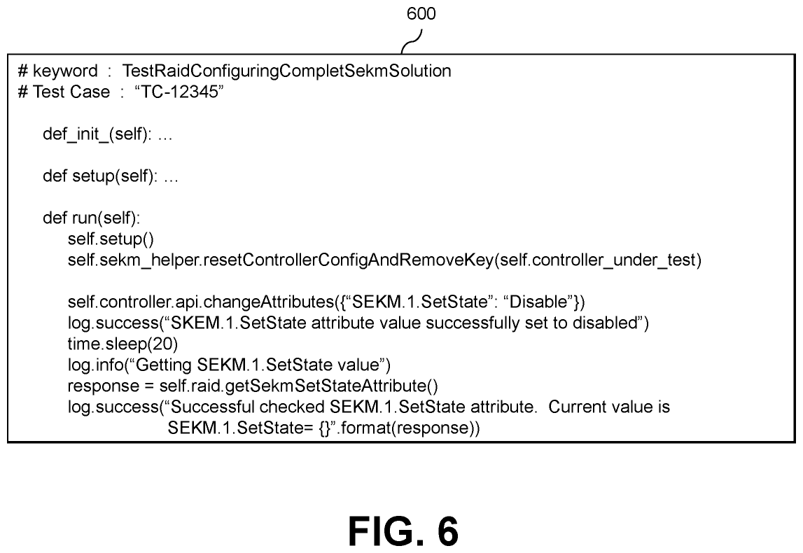

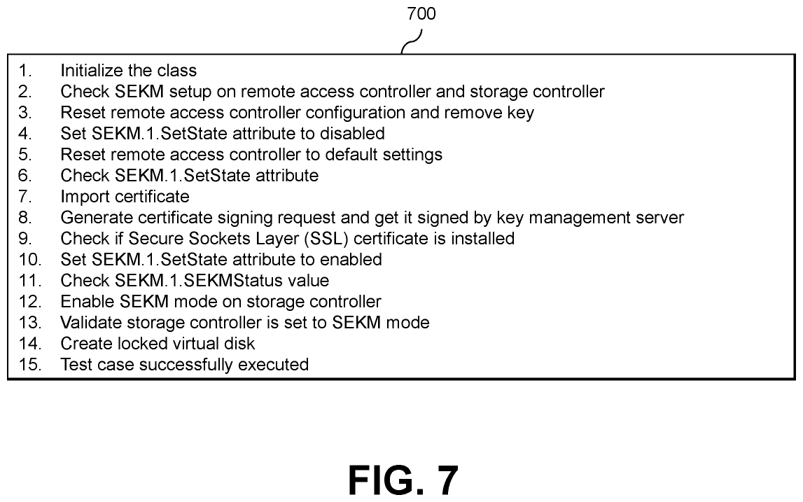

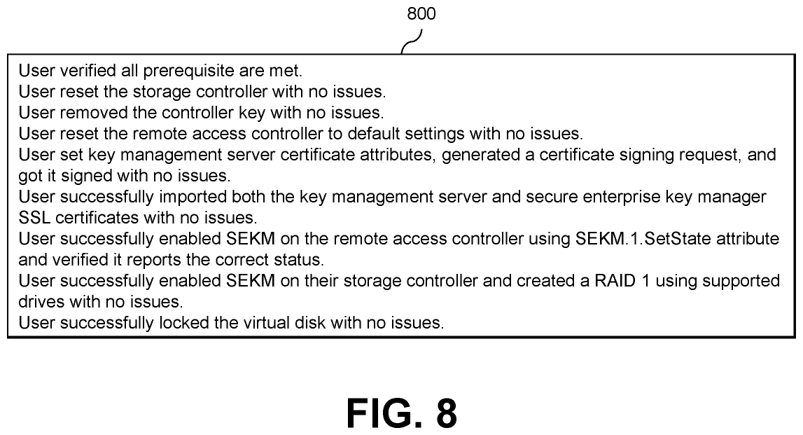

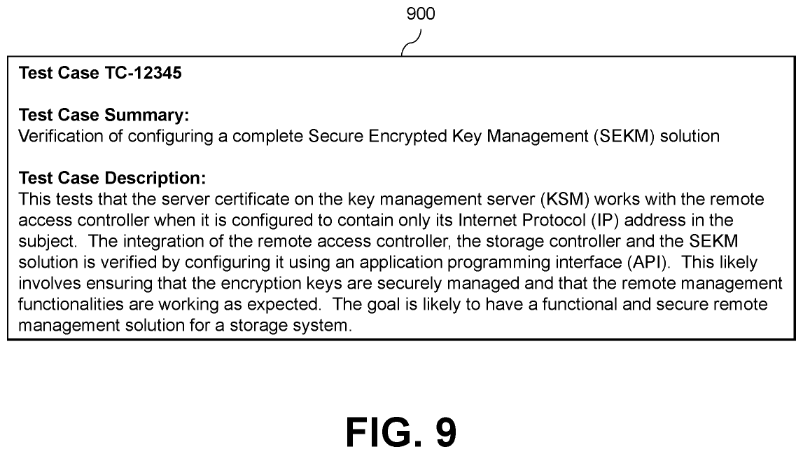

Example implementations of the system flows 300 and 400 will now be described with respect to a list of automated internal test scripts for servers. The automated test scripts were collected as a part of server validation, and stored in an elastic storage database. About 2,000 automated test scripts were considered as an experiment. Once the required data (e.g., a list of most stable test scripts, test case details for those test scripts, and acceptance criteria for those test cases) is collected for a significant number of automated test scripts, the experiment was conducted. FIG. 5 shows a table 500, illustrating a set of most stable test cases from a dataset of more than 2000 automated test scripts. FIG. 6 shows a snippet of functional code 600 for one of the most stable test scripts (i.e., for test case TC-12345 in the table 500). In this example, the test case TC-12345 is for a remote access controller platform (e.g., an Integrated Dell Remote Access Controller (iDRAC)) to verify that configuration of a complete Secure Encrypted Key Management (SEKM) solution is done properly. Using a first LLM (e.g., OpenAI ChatGPT), pseudocode 700 as shown in FIG. 7 is generated for the actual test script (e.g., the test script's functional code shown in FIG. 6). A second LLM is fine-tuned based on test script details, such as test case descriptions and acceptance criteria as described above. The table 500 of FIG. 5 shows examples of test case descriptions. FIG. 8 shows an example of acceptance criteria 800 for the test case TC-12345. Using this acceptance criteria and test case description as input, and the actual test script pseudocode generated by the first LLM, the second LLM (e.g., the open-source Llama 2 LLM) is fine-tuned. The second LLM is fine-tuned utilizing benchmark or gold standard pseudocode collected from the most stable test scripts (e.g., with the lowest failure rate). FIG. 9 shows an example 900 of details for the test case TC-12345, which includes a test case summary and test case description.

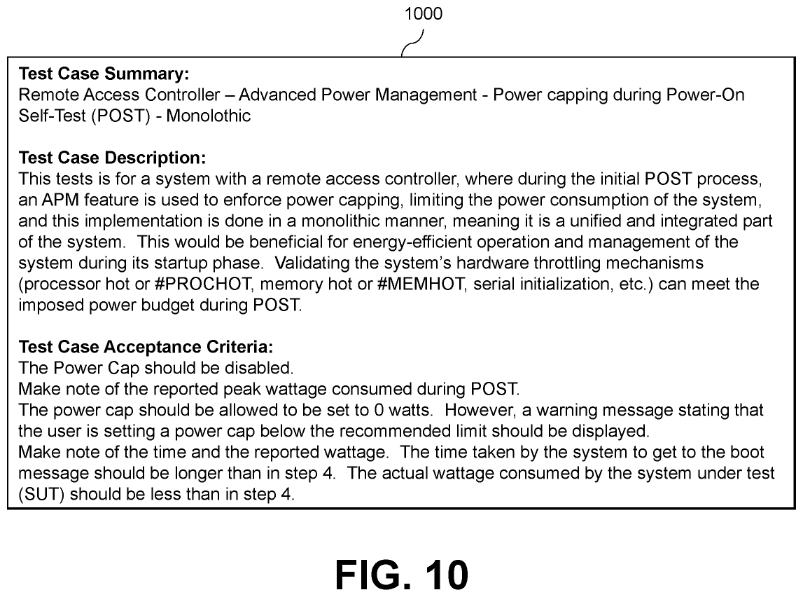

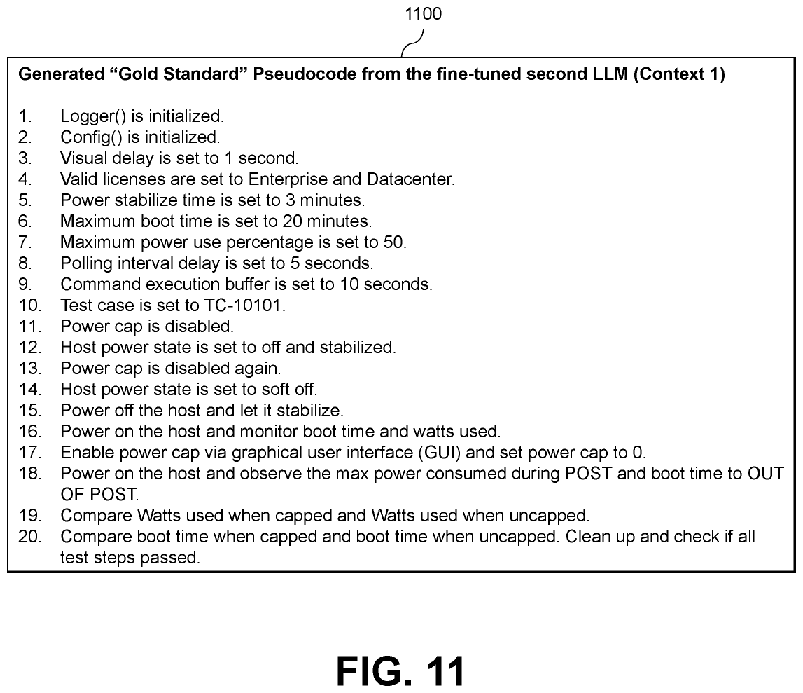

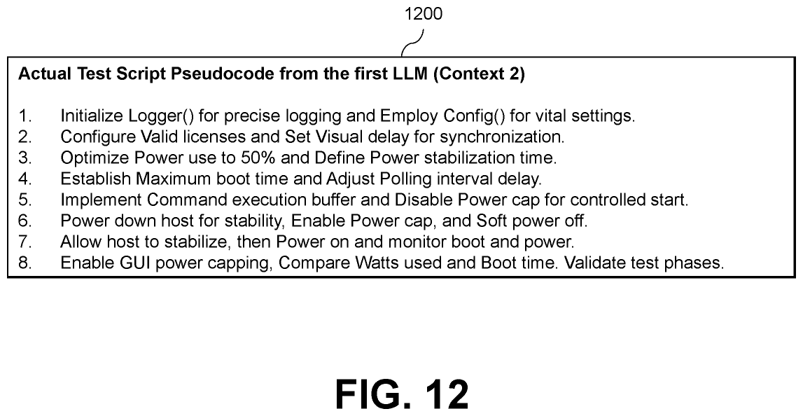

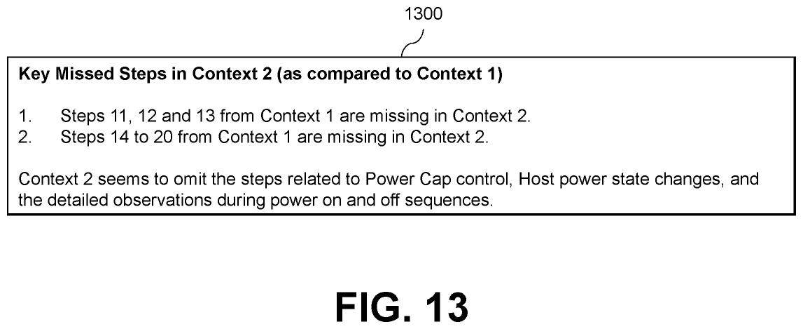

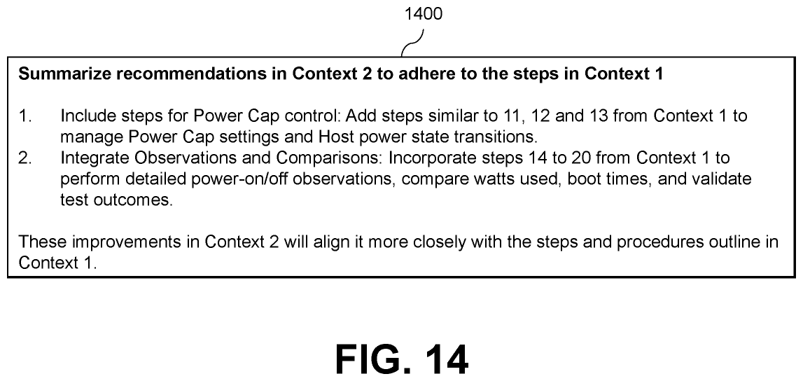

When a new test case (e.g., including a test script, test description and acceptance criteria) emerges, the similarity between actual test script pseudocode generated by the first LLM and a benchmark or gold standard pseudocode generated by the fine-tuned second LLM is determined. In some embodiments, the similarity is calculated utilizing a cosine similarity metric, where a higher cosine similarity indicates a greater stability of the test script created by the developer for the new test case. In some embodiments, a threshold for unstable test scripts is set as below 50% similarity. FIG. 10 shows an example test case 1000 used for inference, including a test case summary, a test case description and test case acceptance criteria. FIG. 11 shows benchmark or gold standard pseudocode 1100, generated using the fine-tuned second LLM, for the example test case 1000 of FIG. 10. FIG. 12 shows actual test script pseudocode 1200, generated using the first LLM, for the example test case 1000 of FIG. 10. In this example, the cosine similar score is 66%. Once the similarity between the actual test script pseudocode 1200 and the benchmark or gold standard pseudocode 1100 is determined, a machine learning model (e.g., an LLM, which may but is not required to be the same as the first LLM) is used to identify the discrepancies in the test script's functional code generated by the developer. FIG. 13 shows an example output 1300 showing the gaps between the actual test script pseudocode 1200 and the benchmark or gold standard pseudocode 1100. A machine learning model (e.g., an LLM, which may but is not required to be the same as the first LLM) is used to generate recommendations 1400 as shown in FIG. 14 for improving the test script (e.g., action items for reducing the gaps between the actual test script pseudocode 1200 and the benchmark or gold standard pseudocode 1100).

The technical solutions described herein provide various technical advantages relative to conventional approaches. For example, conventional approaches typically operate in a reactive manner, triggered by the occurrence of test case failures. Only upon failure detection do test engineers delve into the intricacies to understand the root cause and subsequently identify areas of instability and apply corrective measures. The technical solutions described herein, in contrast, shift the paradigm to an early intervention stage during test script generation itself. By proactively addressing potential issues during the early stages of test script creation, the technical solutions described herein are able to preemptively mitigate instability concerns and preemptively implement corrective measures.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based determination of stability of test scripts associated with test cases will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that may be utilized to implement at least a portion of the information processing system 100 in FIG. 1. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 may comprise respective VMs, respective sets of one or more containers, or respective sets of one or more containers running in VMs.

In some implementations of the FIG. 15 embodiment, the VMs/container sets 1502 comprise respective VMs implemented using virtualization infrastructure 1504 that comprises at least one hypervisor. A hypervisor platform may be used to implement a hypervisor within the virtualization infrastructure 1504, where the hypervisor platform has an associated virtual infrastructure management system. The underlying physical machines may comprise one or more distributed processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1602-1 in the processing platform 1600 comprises a processor 1610 coupled to a memory 1612.

The processor 1610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1612 may comprise random access memory (RAM), read-only memory (ROM), flash memory or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based determination of stability of test scripts associated with test cases as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to select a test case, the selected test case being associated with (i) a test script comprising functional code for implementing the selected test case for testing an information technology asset and (ii) a test case description;
to generate, utilizing a first machine learning model, first pseudocode for the test script based at least in part on the functional code of the test script for the selected test case;
to generate, utilizing a second machine learning model, second pseudocode for the test script based at least in part on the test case description for the selected test case;
to determine a stability of the test script for the selected test case based at least in part on a similarity between the first pseudocode and the second pseudocode; and
to automatically control one or more characteristics of the functional code of the test script for the selected test case based at least in part on the determined stability of the test script for the selected test case.

2. The apparatus of claim 1 wherein the test case description for the selected test case comprises a text summary of the selected test case.

3. The apparatus of claim 1 wherein the test case description for the selected test case comprises at least one of: one or more design documents for software to be tested on the information technology asset; and one or more software requirement specifications for the software to be tested on the information technology asset.

4. The apparatus of claim 1 wherein the test case description comprises acceptance criteria for the selected test case.

5. The apparatus of claim 1 wherein the first machine learning model comprises a first large language model and the second machine learning model comprises a second large language model, the second large language model being different than the first large language model.

6. The apparatus of claim 1 wherein the at least one processing device is further configured to generate one or more recommendations for modifying the functional code of the test script for the selected test case based at least in part on the determined stability of the test script for the selected test case.

7. The apparatus of claim 6 wherein generating the one or more recommendations for modifying the functional code of the test script for the selected test case comprises utilizing the first machine learning model.

8. The apparatus of claim 6 wherein generating the one or more recommendations for modifying the functional code of the test script for the selected test case comprises utilizing a large language model.

9. The apparatus of claim 8 wherein the large language model takes the first pseudocode and the second pseudocode as a text comparative prompt input and produces at least one of the one or more recommendations for modifying the functional code of the test script for the selected test case as output.

10. The apparatus of claim 1 wherein the first machine learning model comprises a large language model that takes the functional code of the test script for the selected test case as a prompt and produces the first pseudocode as an output.

11. The apparatus of claim 1 wherein the second machine learning model comprises a large language model that is tuned utilizing a set of one or more historical stable test cases.

12. The apparatus of claim 1 wherein the at least one processing device is configured to tune the second machine learning model utilizing a set of one or more historical test cases having determined stabilities exceeding a designated stability threshold.

13. The apparatus of claim 12 wherein tuning the second machine learning model comprises:
generating pseudocode for the set of one or more historical test cases utilizing the first machine learning model based at least in part on functional code of test scripts of the set of one or more historical test cases; and
training the second machine learning model utilizing test case descriptions for the set of one or more historical test cases as input and the generated pseudocode for the set of one or more historical test cases as output.

14. The apparatus of claim 1 wherein determining the stability of the test script for the selected test case comprises computing a cosine similarity between the first pseudocode and the second pseudocode.

15. A computer program product comprising a non-transitory processor-readable storage medium having stored therein program code of one or more software programs, wherein the program code when executed by at least one processing device causes the at least one processing device:
to select a test case, the selected test case being associated with (i) a test script comprising functional code for implementing the selected test case for testing an information technology asset and (ii) a test case description;
to generate, utilizing a first machine learning model, first pseudocode for the test script based at least in part on the functional code of the test script for the selected test case;
to generate, utilizing a second machine learning model, second pseudocode for the test script based at least in part on the test case description for the selected test case;
to determine a stability of the test script for the selected test case based at least in part on a similarity between the first pseudocode and the second pseudocode; and
to automatically control one or more characteristics of the functional code of the test script for the selected test case based at least in part on the determined stability of the test script for the selected test case.

16. The computer program product of claim 15 wherein the first machine learning model comprises a first large language model and the second machine learning model comprises a second large language model, the second large language model being different than the first large language model.

17. The computer program product of claim 15 wherein the program code when executed further causes the at least one processing device to generate, utilizing a large language model, one or more recommendations for modifying the functional code of the test script for the selected test case based at least in part on the determined stability of the test script for the selected test case.

18. A method comprising:
selecting a test case, the selected test case being associated with (i) a test script comprising functional code for implementing the selected test case for testing an information technology asset and (ii) a test case description;
generating, utilizing a first machine learning model, first pseudocode for the test script based at least in part on the functional code of the test script for the selected test case;
generating, utilizing a second machine learning model, second pseudocode for the test script based at least in part on the test case description for the selected test case;
determining a stability of the test script for the selected test case based at least in part on a similarity between the first pseudocode and the second pseudocode; and
automatically controlling one or more characteristics of the functional code of the test script for the selected test case based at least in part on the determined stability of the test script for the selected test case;
wherein the method is performed by at least one processing device comprising a processor coupled to a memory.

19. The method of claim 18 wherein the first machine learning model comprises a first large language model and the second machine learning model comprises a second large language model, the second large language model being different than the first large language model.

20. The method of claim 19 further comprising generating, utilizing a large language model, one or more recommendations for modifying the functional code of the test script for the selected test case based at least in part on the determined stability of the test script for the selected test case.
